(19) United States
(12) Patent Application Publication
(10) Pub. No.: US 2025/0206390 A1
(43) Pub. Date: Jun. 26, 2025

(54) TOWING ASSEMBLY

(71) Applicant: PULLIAM ENTERPRISES, INC., MISHAWAKA, IN (US)

(72) Inventors: RANDALL A. PULLIAM, Mishawaka, IN (US); JAMES M. KARASCH, Elkhart, IN (US)

(73) Assignee: PULLIAM ENTERPRISES, INC., MISHAWAKA, IN (US)

(21) Appl. No.: 18/986,891

(22) Filed: Dec. 19, 2024

Related U.S. Application Data
(60) Provisional application No. 63/613,431, filed on Dec. 21, 2023.

(51) Int. Cl. B62D 53/08

(52) U.S. Cl. CPC B62D 53/0828

(57) ABSTRACT

A hitch for coupling a trailer to a towing vehicle includes a hitch assembly and a base assembly. The hitch assembly pivots between an aligned position and a turning position as the towing vehicle turns. A bearing assembly rides between the hitch assembly and the base assembly. The bearing assembly guides the hitch assembly between the turning and aligned positions. The base assembly has an anchor assembly which prevents the hitch assembly from sliding fore or aft when in the aligned position. The base also including a mechanism for distributing forces when installed in a towing vehicle.

### CROSS REFERENCE TO RELATED APPLICATIONS

This non-provisional patent application claims priority to U.S. Provisional Patent Application Ser. No. 63/613,431, filed Dec. 21, 2023, and is hereby incorporated in its entirety by reference.

### BACKGROUND OF THE INVENTION

Fifth wheel trailers and tow vehicles for fifth wheel trailers are generally well known in the art. Fifth wheel trailers are much longer, roomier, and heavier than typical bumper pull campers, and thus a fifth wheel trailer typically requires a specially modified, relatively heavy tow vehicle such as a heavy-duty pickup truck. The front portion of a fifth wheel trailer extends over the rear portion of the tow vehicle so that a fifth wheel hitch in the bed of the pickup truck carries a significant portion of the trailer's weight. The fifth wheel hitch is ideally positioned so the kingpin on the trailer pivots directly over the rear axle of the towing vehicle.

There has been a trend toward extended cab pickup trucks, which have longer, roomier cabs. These trucks have greatly expanded interior cargo volume and also have a second row of seats for accommodating additional passengers. Most of these extended cab pickups are built on a standard wheelbase chassis because consumers prefer the driving characteristics of a shorter truck and, accordingly, the bed of these trucks is typically 6 feet long rather than 8 feet long. Although these shorter bed pickups have the towing capacity to handle fifth wheel trailers, they do not have enough clearance between the axle and the rear of the cab to allow the trailer to pivot to a 90-degree angle without contacting the cab which could damage the truck and severely injure any occupants. In most circumstances, a fifth wheel trailer will contact the cab of a short bed pickup at angles much less than 90 degrees.

Methods for allowing a short bed pickup truck to pull a fifth wheel trailer is to use a sliding towing assembly as described in U.S. Pat. No. 6,308,977 ('977 patent) and 8,220,818 ('818 patent). The '977 patent describes a sliding hitch assembly with two main parts, a base assembly, and a hitch assembly. Likewise, the '818 patent describes a sliding hitch assembly that provides even greater rearward movement than the hitch of the '977 patent. The hitch assemblies of the aforementioned patents attach to the hitch pin box of a trailer and the base assembly is mounted in the bed of a vehicle. The sliding towing assembly operates by mechanically sliding the hitch pin rearward from the cab as the trailer pivots. By sliding the hitch rearward, the distance between the hitch pin and the cab increases during turns, thereby allowing turns up to 90 degrees without the trailer contacting the cab. This motion maintains the position of the kingpin to be over the rear axle when the turning angle is small and moves the kingpin rearward of the rear axle when the turning angle is relatively larger. This optimizes the handling when the towing vehicle speed is high because the turning angle will be relatively small during high speed. It is only at slow speeds when the turning angle is large and having the kingpin being directly over the rear axle is less critical.

The sliding movement of the hitches mentioned above is extremely useful, but that same movement can cause stress to the bed and attachment points of a towing vehicle. As such, it is desirable to have a mechanism that will spread forces within the bed and attachment points for the fifth wheel hitch.

### SUMMARY OF THE INVENTION

The sliding towing assembly, according to the present invention, allows fifth wheel trailers to be towed using short bed pickup trucks. The present sliding towing assembly allows the hitch pin to slide away from the cab, when the truck turns, with minimal friction or noise. The present sliding towing assembly holds the hitch pin in place—preventing the hitch from moving longitudinally, when the truck and trailer are aligned.

The sliding towing assembly is composed of two sub-assemblies: a hitch assembly and a base assembly. The base assembly attaches to the bed of a pickup truck. The hitch assembly latches to a king pin box, thereby connecting the hitch assembly to a trailer. The hitch assembly is carried by the base assembly. The base assembly includes two guide rails. The hitch assembly includes a bushing. The bushing is mounted on a lever arm. A box is carried by the lever arm, about the bushing and contacting the guide rails, thereby guiding the bushing between the guide rails and reducing friction between the base assembly and hitch assembly. A bearing plate rests on top of the guide rails. The bearing plate is sandwiched between the hitch assembly and the guide rails to reduce friction therebetween. The bearing boxes and plate are preferably constructed from a durable plastic with a low coefficient of friction such that they can withstand the forces placed upon them during towing, and reduce friction and dampen noise. Further, the use of plastic bearings reduces the need to use grease or other lubricants on the components of the sliding towing assembly.

When the truck and trailer are aligned—that is, when the truck is not turning—the hitch assembly resides in an aligned position. The base assembly includes a stop member which contacts the bearing boxes when the hitch assembly is in the aligned position. The stop member inhibits forward motion of the hitch assembly during deceleration when the hitch assembly is in the aligned position. The base assembly also has a second stop member which prevents rearward motion of the hitch assembly during deceleration when the hitch assembly is in the aligned position.

Accordingly, it also an object of the present invention to distribute forces that may arise as the hitch assembly slides with respect to the towing vehicle to mitigate the forces on the towing vehicle.

### BRIEF DESCRIPTION OF THE DRAWINGS

FIG. 1 is a perspective view of the towing assembly of the present invention showing the hitch assembly;

FIG. 2 is a perspective view of the towing assembly shown in FIG. 1 showing the bottom of the towing assembly and mounting lugs;

FIG. 3 is a side view of the towing assembly shown in FIGS. 1 and 2 showing the pressure distributing plate in its stored position;

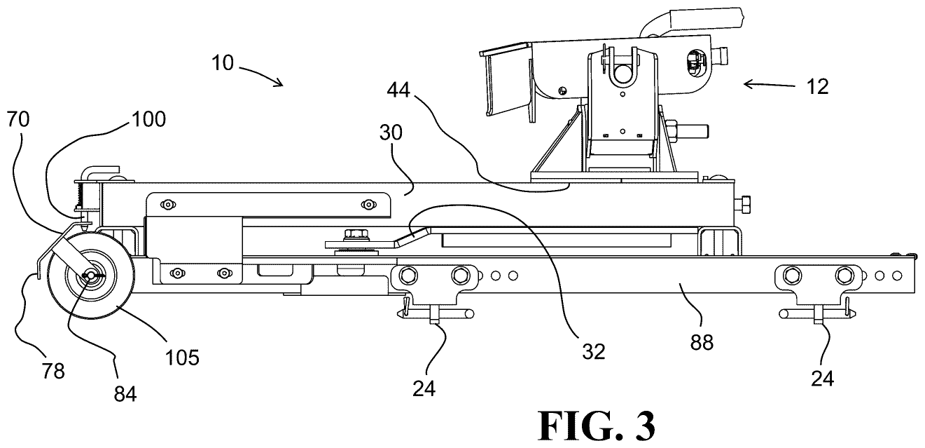

FIG. 4 is a sectional view of the towing assembly shown in FIGS. 1-3 through the center with the pressure distributing plate in its stored position;

FIG. 5 is the sectional view shown in FIG. 4 with the pressure distributing plate in the down position;

FIG. 6 the sectional view shown in FIG. 5 with the pressure distributing plate in the preloaded position;

FIG. 7 is a perspective view of the towing assembly shown in FIGS. 1-6 with portions removed to show the cam in the channel in a turned position with the hitch moved in a rearward position;

FIG. 8 is a perspective view of the towing assembly shown in FIGS. 1-7 with portions removed to show the cam in the channel with the hitch in a forward position corresponding to no turning; and

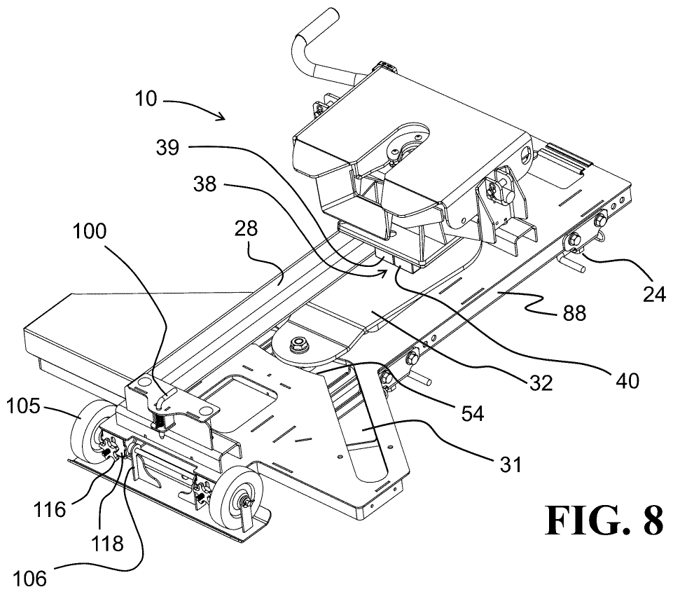

FIG. 9 is an enlarged view of the tensioning know and wheel area that is shown in FIG. 5.

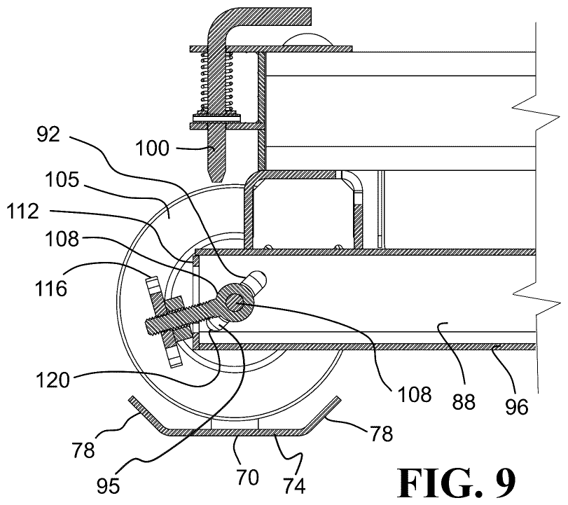

### DESCRIPTION OF THE PREFERRED EMBODIMENT

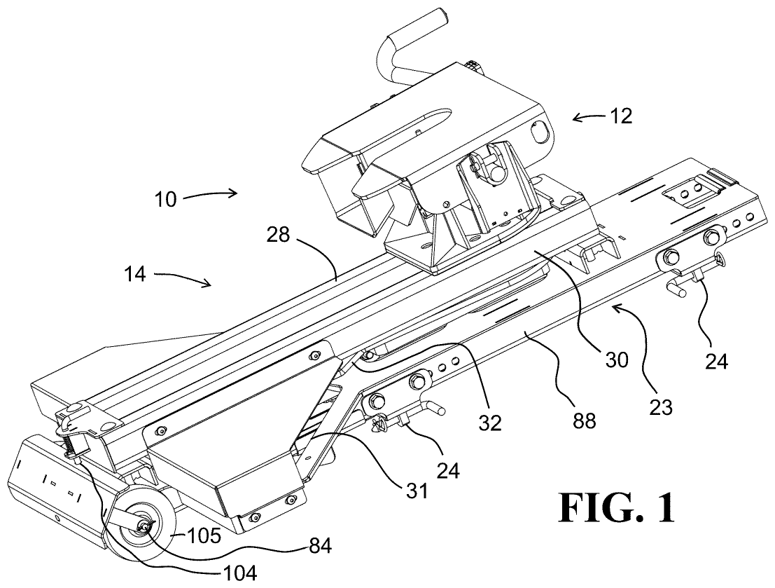

FIG. 1, shows a sliding towing assembly 10 which includes two main parts: a hitch assembly 12 and a base assembly 14. Hitch assembly 12 is carried by base assembly 14. Hitch assembly 12 attaches to a trailer (not shown). Base assembly 14 is mounted in the bed of a truck or similar towing vehicle (not shown) as is known in the art.

Base assembly 14 includes a frame 23, a left guide rail 28, a right guide rail 30, and a channel 31. Guide rails 28 and 30 and channel 31 are carried by frame 23. Frame 23 is supported by mounting lugs 24 which, in turn, are fixed to the vehicle. The lugs 24 are particularly useful with bed rails (not shown), but are well known in the art.

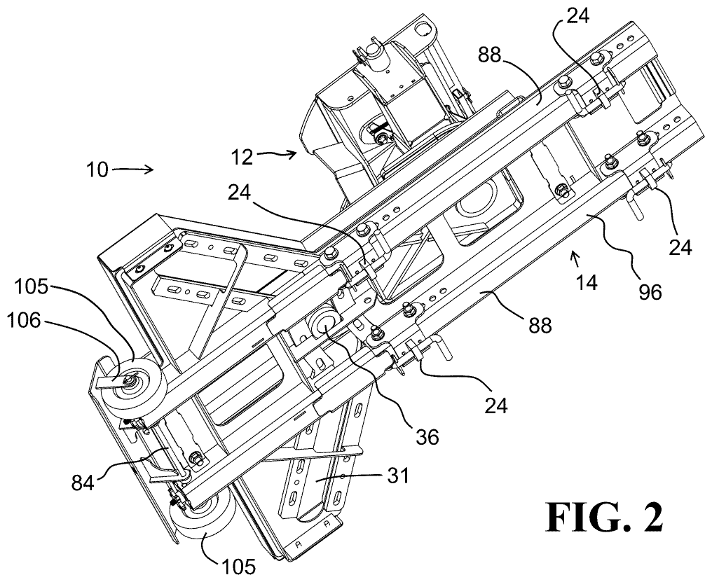

FIG. 2 shows a perspective view of sliding towing assembly 10. Hitch assembly 12 is designed to be locked onto a king pin thereby securing a trailer connected to hitch assembly 12. A capture plate, bolts, or other mechanism is to be attached to the trailer near the kingpin to hold hitch assembly 12 in fixed angular rotation with the trailer at the pin box, as is known in the art.

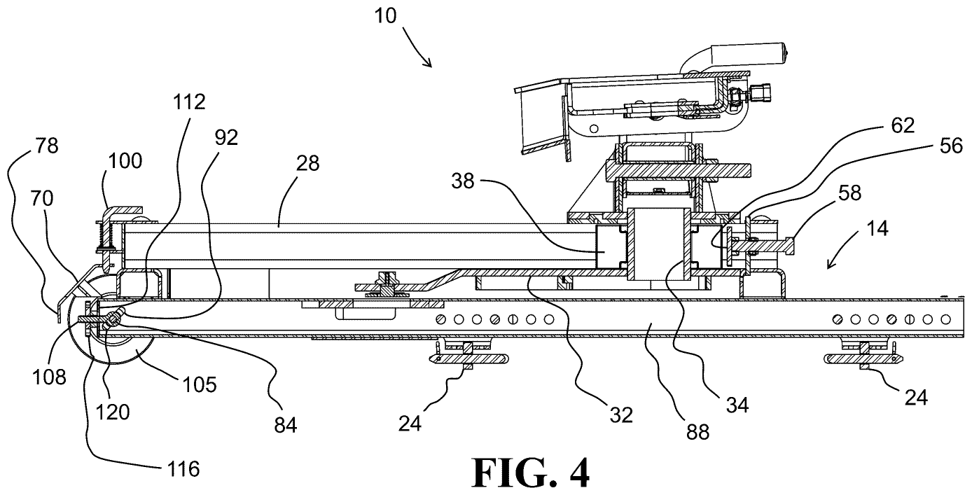

FIGS. 4, 5, and 6 show the towing assembly 10 as a sectional view. Hitch assembly 12 is connected to a bushing 34. Bushing 34 is connected to and supported on a lever arm 32. Lever arm 32 has a cam 36. Lever arm 32 is carried by cam 36. Bushing 34 is fixed to lever arm 32 and to hitch assembly 12 by welding so that hitch assembly 12 remains in rotational alignment with lever arm 32.

Hitch assembly 12 is carried by base assembly 14 with the cam 36 being carried within channel 31 which serves as a cam 36 follower, as shown in FIG. 4.

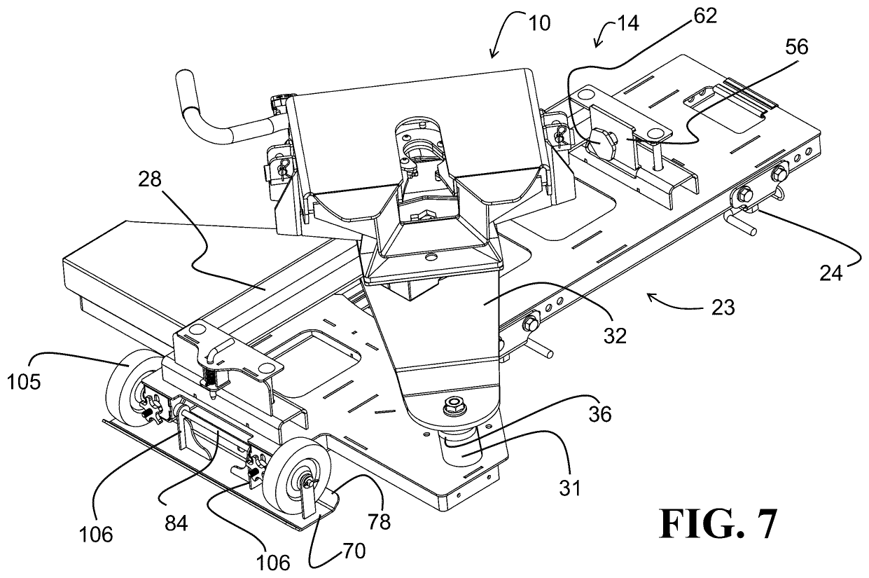

Left guide rail 28 and right guide rail 30 flank bushing 34, as is shown in FIGS. 2 and 7. Guide rails 28 and 30 are, preferably, elongated tubes with a generally square cross-section, which are part of the base assembly 14. Guide rails 28 and 30 are positioned parallel to one another with a gap therebetween.

Base assembly 14 accepts a bearing block 38 that is made of a low friction plastic or other bearing material that facilitates it sliding in its location between the guide rails 28, 30. The bearing block 38 is supported on lever arm 32 and surrounds bushing 34 making contact therewith. The bearing block 38 is slidingly captured between the guide rails 28, 30. The bearing block 38 is made of bearing boxes 39, 40 that are halves of the bearing block 38 that circumscribe the bushing 34. A bearing pad 44 is located to rest on top of guide rails 28 and 30. The bushing 34 extends through the bearing pad 44 as shown in FIG. 4. The bearing pad 44 facilitates smooth sliding of the hitch assembly 12 over the rails 28, 30.

Bearing pad 44 and bearing block 38 are designed to be removable from sliding towing assembly 10, such as when they are worn and need to be replaced. Removal is accomplished by detaching guide rails 28 and 30 from the frame 23. With the guide rails 28, 30 removed, the bearing block 38 can be pulled away from bushing 34, and the bearing pad 44 will drop away from hitch assembly 12. A new bearing block 38 and bearing pad 44 can be installed by following the removal steps in reverse.

FIG. 2 shows a perspective view of frame 23 and the components mounted thereon. Cam 36 is affixed to the underside of lever arm 32. Cam 36 slides within a follower channel 31. Channel 31 is of a general V-shape with a flattened portion 54 at the base of the V. When a rotational force is exerted on lever arm 32 about bushing 34, cam 36 slides along channel 31 causing lever arm 32 and bushing 34 to slide linearly between left guide rail 28 and right guide rail 30. The bearing block 38 serves as a guide as bushing 34 slides between guide rails 28 and 30. In this way, hitch assembly 12 moves along guide rails 28 and 30, when the vehicle turns, thereby increasing the turning radius of the trailer to prevent contact between the trailer and vehicle. The Bearing block 38 further serves to reduce friction, dampen noise, and reduce the need for lubrication.

A plate 56 is mounted to frame 23 behind bushing 34 and opposite channel 31, as shown in FIG. 4-7. Plate 56 carries a set of screws 58 which in turn carries a stop 62. When the vehicle and trailer are aligned, with cam 36 within channel 31 at flattened portion 54, bearing boxes 39 and 40 contact stop 62. Bearing boxes 39 and 40 contact bushing 34, bushing 34 is connected to lever arm 32, lever arm 32 carries cam 36. Stop 62 holds the lever arm 32 flush against flattened portion 54, whereby the channel 31 portion and stop 62 together serve to hold lever arm 32 against longitudinal movement when the vehicle is axially aligned with the connected trailer, preventing hitch assembly 12 from rocking or sliding fore or aft during operation of the vehicle.

Set screw 58 allows for adjustment of stop 62 to allow for variabilities in the manufacturing process of the various components of the sliding towing assembly 10 while still ensuring flush contact between bearing boxes 39 and 40 and stop 62 when the vehicle and trailer are aligned. Adjustment is accomplished by adjusting set screw 58 until stop 62 is brought flush with bearing boxes 39 and 40 when hitch assembly 12 is in the aligned position.

FIG. 7 shows lever arm 32 pivoted into the turning position. As cam 36 travels along channel 31, lever arm 32 is guided between guide rails 28 and 30 by bearing block 38, thereby lengthening the radius of rotation of the trailer to avoid contact between the trailer and vehicle. Bearing pad 44 rotates with hitch assembly 12, as bearing block 38 travels with bushing 34 longitudinally, reducing friction between hitch assembly 12 and guide rails 28 and 30 bearing block 38.

FIG. 7 shows lever arm 32 in the turning position. As a rotational force is exerted on bushing 34 by hitch assembly 12 which is connected to the trailer, cam 36 travels along channel 31 which in turn causes lever arm 32 to carry bushing 34 along guide rails 28 and 30, causing bearing block 38 to slide away from stop 62.

FIG. 2 is a view of base assembly 14 as viewed from below. Lever arm 32 is in the aligned position that corresponds to driving in a straight line. FIG. 2 shows the cam 36 in the channel 31. By sliding lever arm 32 away from stop 62, as shown in FIG. 7, the turning radius of the trailer is elongated so as to avoid contacting the vehicle. Flattened portion 54 is slightly concave, forming an arcuate trough, and thus provides some resistance against cam 36 moving away from portion 54. This concave shape helps prevent unwanted lateral sliding of the cam 36 when the vehicle and trailer are aligned, as the concave shape will cause the cam 36 to remain at the bottom of the trough when bumps or jolts from driving may otherwise cause the cam 36 to rock laterally. Stop 62 braces cam 36 against portion 54 when in the aligned position to prevent longitudinal motion.

Hitch assembly 12 is mounted in fixed rotational contact with the trailer to which it is attached. When the vehicle makes a turn, the trailer pivots relative to the vehicle. Hitch assembly 12 is in fixed rotational contact with bushing 34, and bushing 34 is in fixed rotational contact with lever arm 32. When the trailer pivots, rotational motion causes lever arm 32 to move cam 36 along channel 31. Channel 31 is shaped such that as cam 36 moves laterally, it also pulls lever arm 32 longitudinally, which in turn moves hitch assembly 12 relative to base assembly 14 and away from the cab of the vehicle, thus allowing for a large enough turn radius to prevent the trailer from contacting the towing vehicle.

As can be seen in FIG. 7, this longitudinal movement of the hitch assembly 12 rearward on the frame 14 substantially shifts forces from the weight of the trailer rearward. Typically, the towing assembly 10 is mounted in a truck bed with mounting rails (not shown) that mate with the lugs 24, as is well known in the art. As is apparent from the FIGS., the lugs 24 are relatively near the portion of the frame 23 that is nearest the cab when the hitch 12 is in its aligned position. This is shown in FIGS. 4-6. If the lugs 24 were the only support for the entire towing assembly 10, this would put significant cantilevered stress on the lugs 24 and the structure to which they are attached on the towing vehicle when the hitch 12 is shifted rearward. In an effort to mitigate such stresses that may arise from the use of a towing assembly 10 having a sliding hitch assembly 12, a pressure plate 70 has been included to spread some of the stresses to the bed of the truck.

The pressure plate 70 has a flat planar bottom 74 and angled portions 78 that straddle the bottom 74. The pressure plate 70 is pivotally mounted on an axle 84 that extends through bottom frame rails 88 that are part of the base assembly 14. The pressure plate 70 pivots about the central axis of axle 84. The bottom frame rails 88 are connected to the lugs 24 that act as the connection to the towing vehicle.

The axle 84, on which the pressure plate 70 pivots, rides in inclined slots 92 that are inclined with respect to the bottom surface 96 of the bottom frame rails 88. The inclined slots 92 are at oblique angles with respect to the bottom surfaces 96 of the frame rails 88. Because the bottom frame rails 88 are square tubes, there are four inclined slots 92 in which the axle 84 may slide. Each slot 92 has an upper end 93 that is a first distance from the bottom surface 96 of the bottom frame rails 88 and a lower end 95 that is a second distance from the bottom surface 96 of the frame rails 88. The first distance is greater than the second distance meaning that the upper end 93 of the slots 92 is farther from the bottom surface 96 of the bottom frame rails 88 than the lower end 95 of the slots 92.

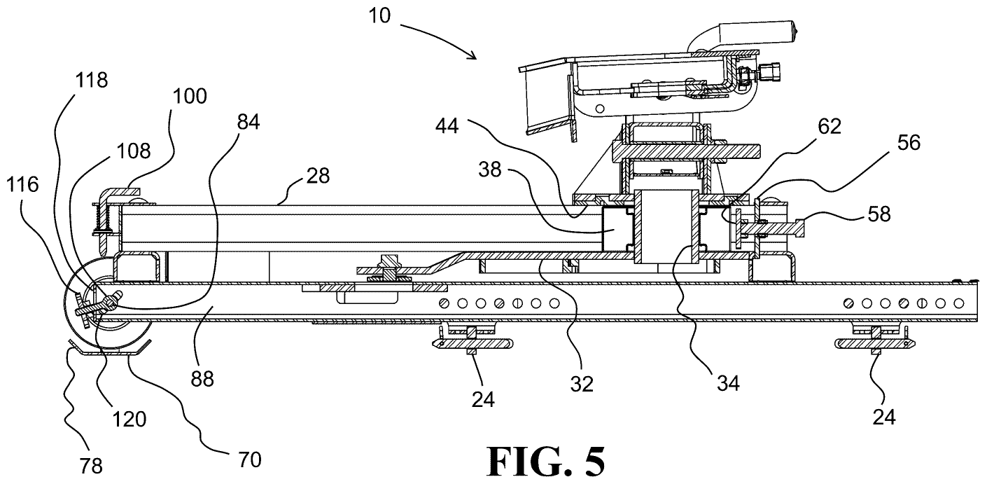

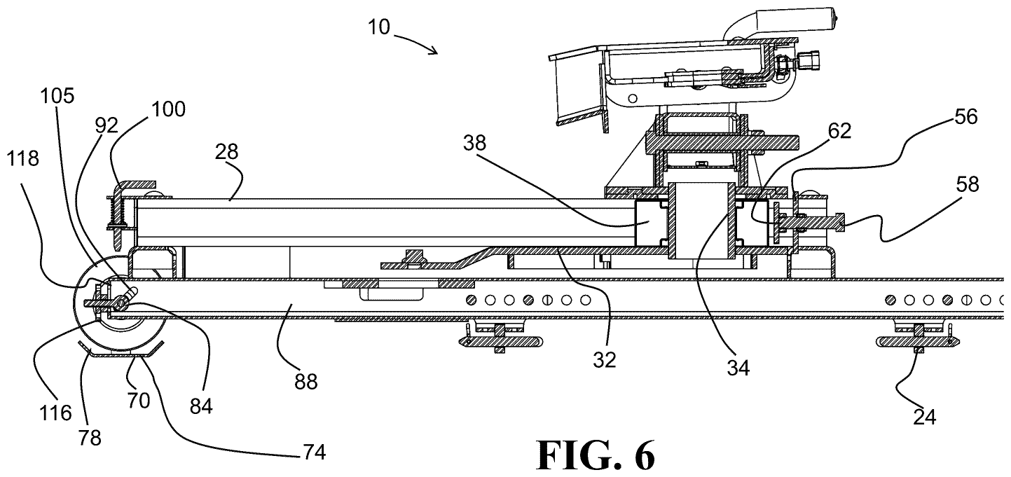

The pressure plate 70 is movable between a stored position (shown in FIG. 4), a down position (shown in FIG. 5), and a preloaded position (shown in FIG. 6). The stored position locates the pressure plate 70 away from the bottom surfaces 96 of the bottom frame rails 88 and away from a bed of a towing vehicle into which the towing assembly is installed. A spring-loaded pin 100 extends into a hole 104 in the pressure plate 70 that holds it in the stored position. When the pressure plate 70 is in the stored position, the wheels 105 that rotate on the same axle 84, are exposed and may be used to roll the towing assembly 10 into position. Arms 106 straddle the wheels 105 and the bottom frame rails 88 with the axle 84 extends through the arms 106. As such, the arms 106 laterally locate the pressure plate 70 and pivotally connect the pressure plate 70 to the axle 84.

Eye bolts 108 circumscribe the axle 84 and extend out of the bottom frame rails 88. The bottom frame rails 88 have end walls 118 through which the eye bolts 108 extend through. A tensioning knob 116 is threaded onto each eye bolt 108 and may be tightened upon the end walls 118 to pull the eye bolts 108 and axles 84 toward the end walls 118 through the action of the mating threads. When the pressure plate 70 is in its down position, the tensioning knobs 116 may be loose and impart no preloading force upon the pressure plate 70 with respect to the bottom frame rails 88 through which the axle 84 extends. The down position may also be characterized as an unloaded or slack position because no force is imparted on the pressure plate 70 via the eye bolts 108. As the tensioning knobs 116 are turned in a tightening direction, the eye bolts 108 will pull the axle 84 toward the end walls 118. This movement of the eye bolts 108 moves the axle 84 away from the upper ends 93 of the slots 92. When this shifting of the axle 84 happens, a preloading force will be put on the pressure plate 70. This preloading force is due to the lower ends 95 of the slots 92 being nearer to the bottom surface 96 of the bottom frame rails 88 than the upper ends 93. Although eye bolts 108 are shown as a mechanism to facilitate preloading, it is contemplated that a lever action and eccentric cam or other mechanism may be used to establish the preloading force that is done with eye bolts 108. Preloading force may be imparted on the pressure plate 70 through the axle 84 until it reaches the bottom end 120 of the inclined slots 92. The preloaded position is considered any position where the tensioning knobs 116 has imparted force upon the pressure plate 70 through its contact with the bed of the towing vehicle. In other words, the preloaded position corresponds with the axle 84 being shifted in the slots 92 to a point where a preloading force is imparted upon the pressure plate 70. Adding a preloading force through tightening of the tensioning knobs 116 causes the pressure plate 70 to distribute force over a relatively large area in a bed of the towing vehicle to which the towing assembly 10 is attached. As such, the pressure plate 70 in the preloaded position shown in FIG. 6, will mitigate some of the stress that would otherwise be taken by the lugs 24. The pressure plate 70 is offset on the base 14 to the substantially opposite end as the forward most lug 24 which greatly reduces any cantilevered forces on the lugs 24.

The present invention is not limited to the details given above, but may be modified within the scope of the following claims.

What is claimed is:

1. A sliding towing assembly, comprising:
a base mounted to a vehicle; and
a hitch assembly attachable to a trailer such that said hitch assembly is in fixed alignment with said trailer, said hitch assembly movably mounted to said base and pivoting between an aligned position and a turning position relative to said base, said aligned position defined by said vehicle and said trailer aligned along a common axis, said turning position defined by said vehicle in angular rotation relative to said trailer such as when said vehicle is turning, said hitch assembly moving longitudinally along said base when pivoting between said aligned position and said turning position;
an axle extending through said base said axle riding in slots, said slots being angled with respect to said base;
a tensioning mechanism for shifting said axle within said slots; and
a pressure plate pivotally mounted to said axle, said axle capable of applying force to said pressure plate when said tensioning mechanism shifts said axle within said slots.

2. Sliding towing assembly as claimed in claim 1, said tensioning mechanism including a bolt partially circumscribing said axle and a mating threaded member wherein turning said threaded member on said bolt shifts said axle within said slots to apply said force.

3. Sliding towing assembly as claimed in claim 2, wherein said axle includes wheels pivotable about said axle.

4. Sliding towing assembly as claimed in claim 2, wherein said pressure plate has a stored position.

5. A sliding towing assembly, comprising:
a base mounted to a vehicle;
a hitch assembly attachable to a trailer such that said hitch assembly is in fixed alignment with said trailer, said hitch assembly movably mounted to said base and pivoting between an aligned position and a turning position relative to said base, said aligned position defined by said vehicle and said trailer aligned along a common axis, said turning position defined by said vehicle in angular rotation relative to said trailer, said hitch assembly moving longitudinally along said base when pivoting between said aligned position and said turning position; and
a bearing assembly nested between said hitch assembly and said base, said bearing assembly serving to guide said hitch assembly as it moves between said turning position and said aligned position;
an axle extending through said base, said axle riding in slots, said slots being angled with respect to said base;
a tensioning mechanism for shifting said axle within said slots; and
a pressure plate pivotally mounted to said axle, said axle capable of applying force to said pressure plate when said tensioning mechanism shifts said axle within said slots.

6. Sliding towing assembly as claimed in claim 5, said tensioning mechanism including a bolt partially circumscribing said axle and a mating threaded member engaging said bolt, wherein turning said threaded member on said bolt shifts said axle within said slots to apply said force.

7. Sliding towing assembly as claimed in claim 6, wherein said axle includes wheels pivotable about said axle.

8. Sliding towing assembly as claimed in claim 6, wherein said pressure plate has a stored position.

9. A towing assembly, comprising:
a hitch affixed to a base, said base including frame members having mounting lugs for being mounted to a towing vehicle, said frame members extending longitudinally and an axle extending through said frame members, said axle riding in slots within said frame and being angled with respect to said frame members;
a tensioning mechanism for shifting said axle within said slots; and
a pressure plate pivotally mounted to said axle, and said axle capable of applying force to said pressure plate when said tensioning mechanism shifts said axle within said slots.

10. The towing assembly of claim 9, wherein said tensioning mechanism includes a bolt partially circumscribing said axle and a mating threaded member engaging said bolt, wherein turning said threaded member on said bolt shifts said axle within said slots to apply said force.

11. The towing assembly of claim 10, wherein said bolt extends through a wall in said frame and said threaded member engaging said bolt is on an opposite side of said wall with respect to said axle and turning said threaded member draws said axle nearer to said wall.

12. The towing assembly of claim 11, wherein said axle includes wheels pivotable about said axle.

13. The towing assembly of claim 11, wherein said pressure plate has a stored position.

14. The towing assembly of claim 9, wherein said frame members have a bottom surface and said frame members each include a slot being angled with respect to said bottom surface, a bolt circumscribing said axle and a threaded member engages said bolt, turning said threaded member on said bolt shifts said axle within said slots and said shifting of said axle within said slots facilitates applying said force to said pressure plate.

15. The towing assembly of claim 14, wherein said bolt extends through an end wall on one of said frame members and turning said threaded member pulls said bolt toward said end wall thereby shifting said axle within said slots.
